(19) United States
(12) Patent Application Publication
(10) Pub. No.: US 2023/0102712 A1
(43) Pub. Date: Mar. 30, 2023

(54) METHOD OF FULLY AUTONOMOUS GEOMETRIC CALIBRATION FOR LINEAR-ARRAY REMOTE SENSING SATELLITES

(71) Applicant: Wuhan University, Wuhan (CN)

(72) Inventors: Mi WANG, Wuhan (CN); Yingdong PI, Wuhan (CN); Bo YANG, Wuhan (CN); Jianya GONG, Wuhan (CN); Zhen LI, Wuhan (CN); Siheng WANG, Wuhan (CN)

(21) Appl. No.: 17/891,129

(22) Filed: Aug. 18, 2022

(30) Foreign Application Priority Data
Sep. 27, 2021 (CN) 202111133459.5

(51) Int. Cl. G01S 3/78; G01S 3/786

(52) U.S. Cl. CPC G01S 3/7803; G01S 3/7867

(57) ABSTRACT

A method of fully autonomous geometric calibration for linear-array remote sensing satellite (LARSS) based on the joint observation for stars and earth by satellite, with the support of satellite's high maneuverability is proposed. This invention realizes the full-link processing from data acquisition to internal and external calibration. Based on the ultra-high attitude stability and agile maneuverability, this invention designs a joint observation mode for the star and the earth, which is suitable for autonomous geometric calibration. With the joint observations, this invention achieves the external calibration through the star observations acquired in the solar shadow area, and achieves the internal calibration through the ground overlapping images acquired in the solar illumination area. Therefore, the high-precision geometric imaging model of the LARSS would be restored by the method, under the condition without using the ground calibration sites.

### CROSS-REFERENCE TO RELAYED APPLICATIONS

Pursuant to 35 U.S.C.§ 119 and the Paris Convention Treaty, this application claims foreign priority to Chinese Patent Application No. 202111133459.5 filed Sep. 27, 2021, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of remote sensing image processing and analysis, and more particularly to a method of fully autonomous geometric calibration for the linear-array remote sensing satellite (LARS S) based on the joint observation for stars and earth.

Geometric calibration is an essential process and important technology to correct the systematic geometric errors in the imaging model of a LARSS. Although the imaging parameters have been strictly calibrated in the laboratory before satellite launch, the real imaging parameters are bound to change due to a variety of factors, such as the variations in the imaging environment, the stress release during the satellite launch, the camera focusing after satellite entering orbit, and so on. Thus, the satellite needs to be re-calibrated in orbit to ensure the geometric accuracy of its images. The traditional in-orbit geometric calibration method uses high-precision digital elevation model (DEM) and digital orthophoto map (DOM) reference data of the ground calibration sites to compensate for the systematic geometric imaging errors of LARSS. However, with the increasing resolution of satellite images and the increasing requirements of various applications for the accuracy and timeliness of satellite images processing, the disadvantages of this method in practical processing are increasingly prominent. First, the expensive construction and maintenance of the calibration sites increase the cost of traditional geometric calibration method. Second, the long revisit period of the satellite and the weather factors severely limits its time window for acquiring images covering the calibration sites, resulting in the long time required for traditional calibration processing, which affects the operational use of the satellite. Third, the reference data of calibration sites are usually produced by aerial photogrammetry, which has been increasingly unable to meet the resolution and accuracy requirements of in-orbit geometric calibration for ultra-high resolution optical remote sensing satellites.

Addressing such problems in the common approaches, the disclosure provides a method of fully autonomous geometric calibration for the LARSS based on the joint observation for stars and earth by satellites. Under the designed agile imaging mechanism, the external calibration for the relative installation relationship between camera and attitude system is achieved through the star observations acquired in the solar shadow area, and the internal calibration for the static distortion of the camera is achieved through the ground overlapping images acquired in the solar illumination area. Therefore, the high-precision geometric imaging model of the remote sensing would be restored, under the condition without using the ground calibration sites.

### SUMMARY

The disclosure provides a method of fully autonomous geometric calibration for LARSS based on the joint observation for stars and earth by satellites. The method comprises:

obtaining the star images in the solar shadow region based on satellite agile maneuvers and extracting star positions from star images; and

constructing the on-orbit geometric external calibration model based on the generalized installation angles and rigorous star imaging model; and

estimating the external calibration parameters based on sequential star observations, in which the collinearity relationship between imagery point and star point is used to construct the adjustment model, and the least squares adjustment algorithm is adopted for parameters estimation; and

obtaining the ground overlapping images in the solar illumination region based on satellite's agile mobility and the overlap requirements, and identity dense corresponding imagery points from overlapping images; and

constructing the internal calibration model by introducing the fitted viewing angle model into the rigorous earth imaging model; and

estimating the internal calibration parameters based on coplanar constraints between overlapping images, constructing the adjustment model for internal calibration through using the common ground coordinates as the connection to express the coplanar condition of corresponding imagery points, performing the absolute internal calibration CCD by CCD to compensate for the absolute distortion of each CCD, performing the relative internal calibration of all CCDs through overall adjustment, so that the high precision geometric registration and splicing among CCD images are obtained.

Two stages in the method, including external calibration and internal calibration, which are performed based on the star images and ground overlapping images respectively, aiming at systematic external and internal orientation errors of satellite's imaging links.

Compared with the existing technology, the disclosure has the following beneficial effects: the star and the ground overlapping images are used as the observations, instead of the high precision reference data of calibration sites, which overcomes the shortcomings of traditional methods due to the strong dependence on the ground calibration sites, reducing the calibration cost and improving the calibration timeliness. The joint autonomous calibration mode combining star and earth observations is established to ensure that all systematic geometric errors in the imaging link can be effectively compensated. The segmented absolute geometric distortion calibration and overall relative distortion calibration is jointed in internal calibration, which not only realizes the distortion compensation, but also achieves the accurate geometric splicing among segmented CCDs.

### BRIEF DESCRIPTION OF THE DRAWINGS

FIG. 1 is a flowchart of the method of external calibration using star observations and the internal calibration using ground overlapping images;

FIG. 2 is a schematic diagram of acquiring star observations based on the agile mobility of the LARSS;

FIG. 3 is a schematic diagram of collecting ground overlapping images in the same orbit circle based on the agile mobility of the LARSS;

FIG. 4 is a diagram of the distributions of ground overlapping images and their corresponding imagery points; and

FIG. 5 is a schematic diagram of CCD distortion in different stages after absolute and relative calibration in internal geometric calibration.

### DETAILED DESCRIPTION

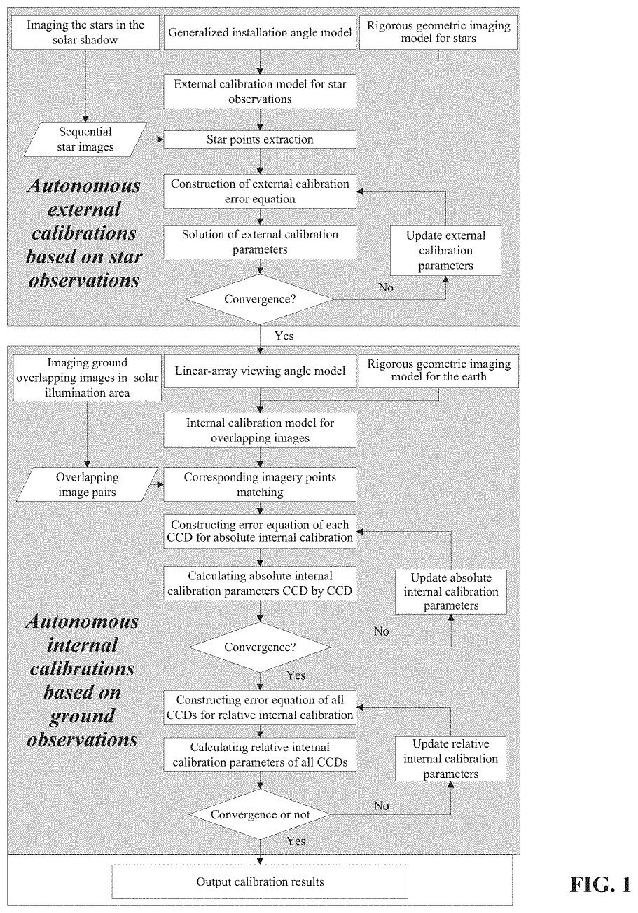

FIG. 1 is a flowchart that illustrates the method of fully autonomous geometric calibration for the LARSS based on the joint observation of stars and earth by satellites. A further detailed description of the method is given below for each step in the embodiments.

Step 1: Obtain the star images in the solar shadow region based on satellite agile maneuvers, and extracting star positions from star images.

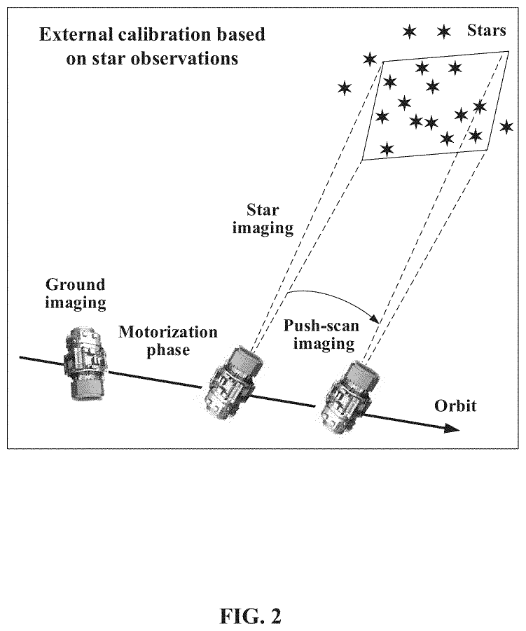

FIG. 2 is the schematic diagram showing the satellite from earth imaging to star imaging. Since the number, distribution and magnitude of stars vary from one celestial zone to another, these conditions of stars in the different celestial zones needs to be considered when collecting star images. The whole celestial region is divided into zones according to satellite camera's field of view, and the zone with suitable star number, distribution and magnitude is selected as the observation zone according to the imaging sensitivity of the camera. By adjusting the satellite's attitude, the sequential star-viewing images are obtained.

Then, the precise star points are extracted by image processing methods such as image denoising, binarization, edge extraction and center-of-mass fitting with the aid of the navigation catalog to obtain the right ascension and declination of each star point.

Step 2: Construct the on-orbit geometric external calibration model based on the generalized installation angles.

This step further includes the following sub-steps:

Step 2.1: According to the right ascension α and declination δ of a star point, its star observation vector in the celestial coordinate system can be determined by vₛₜₐᵣ=(cos α cos δ, sin α cos δ, sin δ)^{T}, and then based on the co-linearity between the star observation vector and the satellite viewing vector vₛₐₜ, a rigorous geometric imaging model of star imaging for the LARSS image can be established as follows:

$$( \begin{matrix}tan {φ}_{s} \\ tan {φ}_{y} \\ 1\end{matrix} ) = μ {R}_{Body}^{Cam} ( φ , ω , κ ) {R}_{J 2000}^{Body} {R}_{Aber} [ \begin{matrix}cos α cos δ \\ sin αcos δ \\ sin δ\end{matrix} ] \qquad ( 1 )$$

In which, φₓ and φ_{y} are the viewing-angle of the image point in the across and along the CCD directions within the camera. μ is the scaling factor; R_{J 2000}^{Body} is the rotation matrix from the J2000 coordinate system to the satellite body coordinate system, which is obtained by the attitude of the satellite; R_{Aber} is the correction matrix for optical aberration, which can be determined by the optical aberration angle θ and the rotation vector n, the determination of the correction matrix R_{Aber} as follows:

$${R}_{Aber} = {[ \begin{matrix}{p}_{1}^{2} - {p}_{2}^{2} - {p}_{3}^{2} + {p}_{0}^{2} & 2 ( {p}_{1} {p}_{2} + {p}_{3} {p}_{0} ) & 2 ( {p}_{1} {p}_{3} - {p}_{2} {p}_{0} ) \\ 2 ( {p}_{1} {p}_{2} - {p}_{3} {p}_{0} ) & - {p}_{1}^{2} + {p}_{2}^{2} - {p}_{3}^{2} + {p}_{0}^{2} & 2 ( {p}_{2} {p}_{3} + {p}_{1} {p}_{0} ) \\ 2 ( {p}_{1} {p}_{3} + {p}_{2} {p}_{0} ) & 2 ( {p}_{2} {p}_{3} - {p}_{1} {p}_{0} ) & - {p}_{1}^{2} - {p}_{2}^{2} + {p}_{3}^{2} + {p}_{0}^{2}\end{matrix} ]}^{T} \qquad ( 2 )$$

$${p}_{0} = {n}_{x} cos ( \frac{θ}{2} ) , {p}_{1} = {n}_{x} sin ( \frac{θ}{2} ) , {p}_{2} = {n}_{y} sin ( \frac{θ}{2} ) , {p}_{3} = {n}_{z} sin ( \frac{θ}{2} ) \qquad ( 3 )$$

$$θ = ν sin β / c \qquad ( 4 )$$

$$n = ( {n}_{x} , {n}_{y} , {n}_{z} ) = \frac{{v}_{star} \times {v}_{sat}}{‖ {v}_{star} \times {v}_{sat} ‖} \qquad ( 5 )$$

In which, P=(p₀, p₁, p₂, p₃) is the transformation quaternion; v is the velocity of the satellite; c is the speed of light; β is the included angle between the star observation vector vₛₜₐᵣ and the satellite viewing vector vₛₐₜ.

By separating the optical aberration error in the star imaging model, it is ensured that the installation angle determined by the star-based external calibration is consistent with that in the earth imaging model of internal calibration, so as to ensure the complementarity of the internal and external calibration without coupling.

Step 2.2: The external calibration model constructed in this invention is shown in Eq. (6). R_{Body}^{Cam} is a generalized installation matrix from the satellite body coordinate system to the camera coordinate system, and all the errors of the external orientation parameters are unified into this matrix for compensation, which is determined by the three camera installation angles (φ, ω, κ), as follows:

$${R}_{Body}^{Cam} = [ \begin{matrix}cos φ & 0 & sin φ \\ 0 & 1 & 0 \\ - sin φ & 0 & cos φ\end{matrix} ] [ \begin{matrix}1 & 0 & 0 \\ 0 & cos ω & - sin ω \\ 0 & sin ω & cos ω\end{matrix} ] [ \begin{matrix}cos κ & - sin κ & 0 \\ sin κ & cos κ & 0 \\ 0 & 0 & 1\end{matrix} ] \qquad ( 6 )$$

Step 3: Estimate the external calibration parameters based on sequential star observations.

This step further includes the following sub-steps:

Step 3.1: The least squares adjustment is used to estimate the external calibration parameters, and the adjustment model for parameters solution is first established based on the geometric calibration model. The constructed adjustment model (Gₓ, G_{y}) is as follows:

$$\{ \begin{matrix}{G}_{x} = \overline{X} - \overline{Z} \cdot tan {φ}_{x} \\ {G}_{y} = \overline{Y} - \overline{Z} \cdot tan {φ}_{y}\end{matrix} \qquad ( 7 )$$

In which,

$$( \begin{matrix}\overline{X} \\ \overline{Y} \\ \overline{Z}\end{matrix} ) = μ {R}_{Body}^{Cam} ( φ , ω , κ ) {R}_{J 2000}^{Body} {R}_{Aber} [ \begin{matrix}cos α cos δ \\ sin αcos δ \\ sin δ\end{matrix} ] \qquad ( 8 )$$

For each star point, the adjustment equation used for the parameters solution is established according to Eq. (7) based on its imaging time, attitude and current calibration parameters.

Step 3.2: Based on the adjustment equation, the error equation for i-th star point can be constructed by model linearization:

v_{E}ⁱ=Aᵢx−L (9)

In which, x=[dφ, dω, dκ]^{T} is the correction vector for the installation angles; Aᵢ is the coefficient matrix of the error equation for a star point; Lᵢ is the corresponding constant vector of the error equation, as follows:

$${A}_{i} = [ \begin{matrix}\frac{\partial {G}_{x}}{\partial φ} & \frac{\partial {G}_{x}}{\partial ω} & \frac{\partial {G}_{x}}{\partial κ} \\ \frac{\partial {G}_{y}}{\partial φ} & \frac{\partial {G}_{y}}{\partial ω} & \frac{\partial {G}_{y}}{\partial κ}\end{matrix} ] , \\ {L}_{i} = {[ \begin{matrix}- {G}_{x} \\ - {G}_{y}\end{matrix} ]}_{i} \qquad ( 10 )$$

Based on the least squares theory, the estimation of x can be deduced:

$$x = {( {{\sum }^{m}}_{i = 1} {A}_{i}^{T} {A}_{i} )}^{T} ( {{\sum }^{m}}_{i = 1} {A}_{i}^{T} {L}_{i} ) \qquad ( 11 )$$

In which, m is the number of star points.

The estimation of the external parameters is an iterative process, the current values of the parameters are updated according to the estimated corrections, and used as inputs in next solution. The iteration ends when the difference between the results of the two successive solutions is less than the limit threshold.

Step 4: Obtain the ground overlapping images in the solar illumination region based on satellite's agile mobility, and identity dense corresponding imagery points from overlapping images.

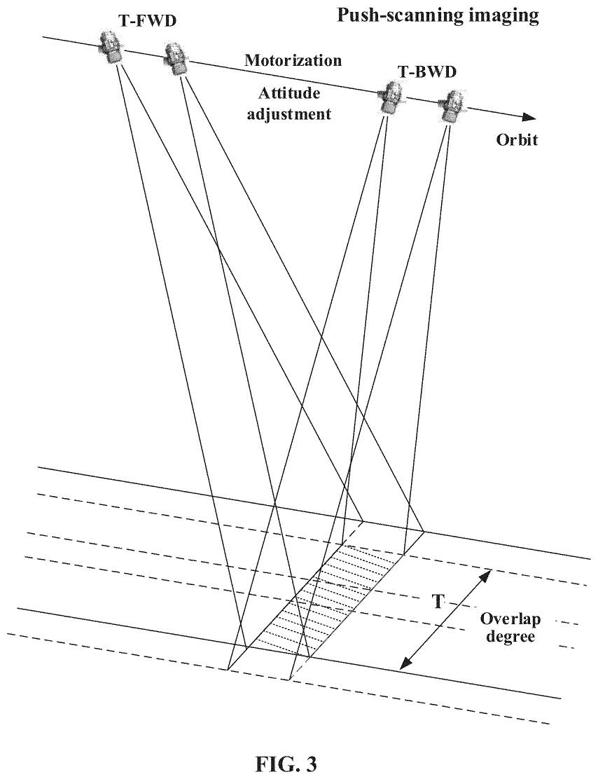

FIG. 3 is a schematic diagram of a LARSS acquiring the overlapping images. When the satellite orbits to the solar illumination region, the satellite begins to collect the overlapping images using its maneuvering ability in three phases. In “T-FWD” phase, an image covering the earth's surface is obtained. Then the satellite adjusts its attitude according to the overlap requirements in the calibration (Motorization phase). Finally, in the third “B-FWD” phase, another overlapping image satisfying overlapping degree is obtained.

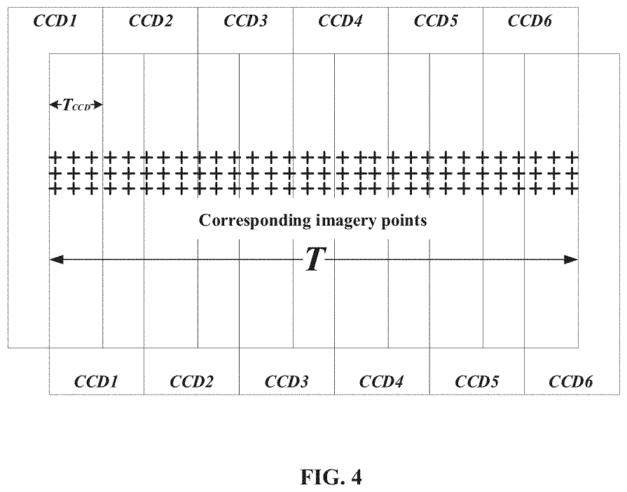

FIG. 4 is the schematic diagram showing the overlap condition of the acquired two scenes overlapping images through three stages. Since the linear-array satellite camera is usually composed of multiple CCDs (it is assumed that there are 6 CCDs in FIG. 4), and the distortions of each CCD are different, each CCD needs to have different parameters to be calibrated in the internal calibration, and each CCD needs to be processed separately. Therefore, the two images acquired by each CCD needs to have a certain overlap degree T_{CCD}, which is required in this invention to be between 45% and 75%, and the best T_{CCD} is 65%. The relationship between the overall overlap degree T and that of each CCD is as follows:

$$T = 1 - \frac{1 - {T}_{C C D}}{n} \qquad ( 12 )$$

In which, n is the number of CCDs.

FIG. 4 also shows the distribution of identified corresponding imagery points in the overlapping area of the two scenes of images. In order to limit the effect of the random jitter of the attitude fitting error that can bring nonlinear error to the internal calibration, the corresponding imagery points are identified in a shorter section of the line (along the orbit) direction of the overlapping images.

Step 5: Construct the internal calibration model based on the coplanar constraints between overlapping images.

This step further includes the following sub-steps:

Step 5.1: Obtain the imaging time of the corresponding imagery points according to their imagery line number, and then interpolate the attitude and the orbit parameters according to the imaging time. Therefore, the rigorous imaging model for ground observation is established based on the relationship among the imagery point, ground point and projection center, the model is as follows:

$$( \begin{matrix}tan {φ}_{x} \\ tan {φ}_{y} \\ 1\end{matrix} ) = μ {R}_{Body}^{Cam} ( φ , ω , κ ) {R}_{J 2000}^{Body} {{R}_{WGS 84}^{J 2000} [ \begin{matrix}{X}_{g} - {X}_{gps} \\ {Y}_{g} - {Y}_{gps} \\ {Z}_{g} - {Z}_{gps}\end{matrix} ]}_{WGS 84} \qquad ( 13 )$$

In which, R_{Body}^{Cam} is still the rotation matrix from the satellite body coordinate system to the camera coordinate system, determined by the above external calibration; R_{WGS84}^{J2000} is the rotation matrix from the WGS84 coordinate system to the J2000 coordinate system, determined by the ephemeris parameters at the moment of imaging; R_{J2000}^{Body} is the same as that in the imaging model for the stars; (X_{gps}, Y_{gps}, Z_{gps}) represents the coordinates of the GPS antenna phase center in the WGS84 coordinate system, obtained by the GPS receiver on the satellite; (X_{g}, Y_{g}, Z_{g}) represents the ground 3D coordinates of the corresponding imagery points in the WGS84 coordinate system. The transformation between the geographic coordinates (Lat, Lon, Hei) (latitude, longitude, elevation) and 3D coordinates is as follows:

$$\{ \begin{matrix}{X}_{g} = ( N + Hei ) cos Lat cos Lon \\ {Y}_{g} = ( N + Hei ) cos Lat sin Lon \\ {Z}_{g} = ( N ( 1 - {e}^{2} ) + Hei ) sin Lat\end{matrix} \qquad ( 14 )$$

In which, N is the radius of the Earth's curvature in prime vertical, and e is the first eccentricity of the Earth's ellipsoid.

Step 5.2: For the viewing of each CCD detector of a linear-array camera, its viewing angle in the camera coordinate system can be expressed by (φₓ, φ_{y}) accurately. According to the distortion characteristics of the LARS S cameras, the viewing angle (φₓ, φ_{y}) of each detector can be fitted using two cubic polynomials, and then the internal calibration model based on the fitted viewing angle is constructed:

$$\{ \begin{matrix}tan {φ}_{x} = {a}_{0} + {a}_{1} s + {a}_{2} {s}^{2} + {a}_{3} {s}^{3} \\ tan {φ}_{y} = {b}_{0} + {b}_{1} s + {b}_{2} {s}^{2} + {b}_{3} {s}^{3}\end{matrix} \qquad ( 15 )$$

In which, s is the number of CCD detector, and (a₀, a₁, a₂, a₃, b₀, b₁, b₂, b₃) are the coefficients of cubic polynomials, also the internal calibration parameters need to be determined.

By introducing the constructed internal calibration model of each CCD into the rigorous geometric imaging model, the on-orbit geometric calibration model is obtained, in which each CCD has its own set of internal calibration parameters to be solved.

Step 6: Stepwise estimation of the internal calibration parameters based on coplanar constraints between overlapping images.

This step further includes the following sub-steps:

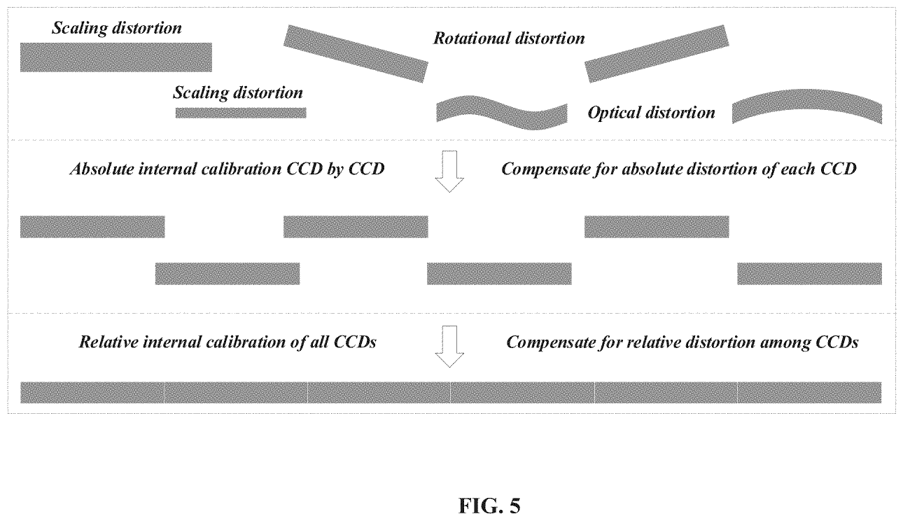

FIG. 5 is a schematic diagram of CCD distortion in different stages after absolute and relative calibration in internal geometric calibration. Before internal geometric calibration, the CCDs of the camera have various distortions with inconsistent properties and sizes (rotational distortion, scaling distortion, optical distortion, etc., or comprehensive distortion coupled with these distortions), resulting in low image geometric quality and accuracy. After the absolute calibration, the absolute distortion of each CCD is well corrected, but there is still relative geometric distortion among CCDs, resulting in the inability of accurate splicing among CCDs. Further, the relative distortion is corrected in the relative calibration, to improve the geometric splicing accuracy among the CCDs.

Step 6.1: The least squares adjustment is used to solve the parameters in absolute internal calibration, so the adjustment model (16) for parameters solution is first established based on the calibration model.

$$\{ \begin{matrix}{F}_{x} = \overline{U} - \overline{W} \cdot tan {φ}_{x} \\ {F}_{y} = \overline{V} - \overline{W} \cdot tan {φ}_{y}\end{matrix} \qquad ( 16 )$$

In which,

$$( \begin{matrix}\overline{U} \\ \overline{V} \\ \overline{W}\end{matrix} ) = μ {R}_{Body}^{Cam} ( φ , ω , κ ) {R}_{J 2000}^{Body} {{R}_{WGS 84}^{J 2000} [ \begin{matrix}{X}_{g} - {X}_{gps} \\ {Y}_{g} - {Y}_{gps} \\ {Z}_{g} - {Z}_{gps}\end{matrix} ]}_{WGS 84} \qquad ( 17 )$$

It should be noted that, the models of different CCDs are determined by the respective viewing angle models in the adjustment model.

Step 6.2: On the basis of the external calibration, the above estimated external calibration parameters are considered as true values in internal calibration. For each CCD, its internal calibration parameters are estimated separately using the dense corresponding imagery points on its overlapping images. Since the constant term (a₀, b₀) is independent of the coplanar constraints between the images, the translation error of the constant term parameters is allocated to the external calibration for compensation, rather than in the internal calibration. Therefore, only the other higher order parameters are calculated in the CCD-by-CCD absolute internal calibration. According to the constructed adjustment model, the error equation can be constructed for each pair of corresponding imagery point by linearizing the model:

$$\{ \begin{matrix}{v}_{IH}^{Fi} = {B}_{i}^{F} y + {C}_{i}^{F} {t}_{i} - {R}_{i}^{F} \\ {v}_{IH}^{Bi} = {B}_{i}^{B} y + {C}_{i}^{B} {t}_{i} - {R}_{i}^{B}\end{matrix} \qquad ( 18 )$$

In which, v_{IH}^{Fi} and v_{IG}^{Bi} are the correction vectors corresponding to the imagery points on the T-FWD and T-BWD images, respectively, y=[da₁, da₂, da₃, db₁, db₂, db₃]^{T} is the correction vectors of the calibration parameters for a CCD; tᵢ=[dLat,dLon]ᵢ^{T} is the correction vectors of the ground plane coordinates of each corresponding imagery point, and its ground elevation is interpolated from the DEM of the image coverage area, the ground flat area should be selected for internal calibration as far as possible, so the open source DEM could usually meet the calibration accuracy requirements; the matrices and Bᵢ^{B} are the partial derivative coefficient matrices on the calibration parameters in the error equations of the T-FWD and T-BWD image points, respectively; the matrices Cᵢ^{F} and Cᵢ^{B} are the partial derivative coefficient matrices on the ground plane coordinates in the error equation for the T-FWD and T-BWD imagery points, respectively; Rᵢ^{F} and Rᵢ^{B} are the constant vectors in the error equation for the T-FWD and T-BWD imagery points, respectively. Taking the image point on the T-FWD image as an example, the specific form of each matrix in the error equation is as follows:

$${B}_{i}^{F} = {[ \begin{matrix}\frac{\partial {F}_{x}^{F}}{\partial {a}_{1}} & \frac{\partial {F}_{x}^{F}}{\partial {a}_{2}} & \frac{\partial {F}_{x}^{F}}{\partial {a}_{3}} & 0 & 0 & 0 \\ 0 & 0 & 0 & \frac{\partial {F}_{y}^{F}}{\partial {b}_{1}} & \frac{\partial {F}_{y}^{F}}{\partial {b}_{2}} & \frac{\partial {F}_{y}^{F}}{\partial {b}_{3}}\end{matrix} ]}_{i} {C}_{i}^{F} = {[ \begin{matrix}\frac{\partial {F}_{x}^{F}}{\partial Lat} & \frac{\partial {F}_{x}^{F}}{\partial Lon} \\ \frac{\partial {F}_{y}^{F}}{\partial Lat} & \frac{\partial {F}_{y}^{F}}{\partial Lon}\end{matrix} ]}_{i} {R}_{i}^{F} = {[ \begin{matrix}- {F}_{x}^{F} \\ - {F}_{y}^{F}\end{matrix} ]}_{i} \qquad ( 19 )$$

Therefore, the estimation of y can be deduced according to the least squares adjustment:

$$y = {( {\sum }_{i = 1}^{k} ( {B}_{i}^{T} {B}_{i} - {B}_{i}^{T} {{C}_{i} ( {C}_{i}^{T} {C}_{i} )}^{- 1} {C}_{i}^{T} {B}_{i} ) )}^{- 1} ( {\sum }_{i = 1}^{k} ( {B}_{i}^{T} {R}_{i} - {B}_{i}^{T} {{C}_{i} ( {C}_{i}^{T} {C}_{i} )}^{- 1} {C}_{i}^{T} {R}_{i} ) ) \qquad ( 20 )$$

In which, k is the number of corresponding imagery points on the overlapping image of this CCD, and

$${B}_{i} = [ \begin{matrix}{B}_{i}^{F} \\ {B}_{i}^{B}\end{matrix} ] , {C}_{i} = [ \begin{matrix}{C}_{i}^{F} \\ {C}_{i}^{B}\end{matrix} ] , {R}_{i} = [ \begin{matrix}{R}_{i}^{F} \\ {R}_{i}^{B}\end{matrix} ] ,$$

Similarly, the internal calibration solution is also an iteration process, and the current internal calibration parameters are updated according to the estimated corrections in each iteration, and be used as the inputs in the next iteration. The iterative solution ends when the estimated corrections in two consecutive iterations is less than a threshold. Given that the process of solving the high order internal calibration parameters is the same for each CCD, so the solutions for other CCDs are not repeated here.

Step 6.3: To ensure the geometric splicing accuracy among the CCDs, it is necessary to register the constant terms of all CCD under the same external calibration parameters. The corresponding imagery points between the overlapping images of adjacent CCDs are used as the observations to perform relative internal calibration. A CCD is chosen as the reference CCD, and its constant term is regarded as true values and not calculated. The constant terms of all non-reference CCDs are estimated with the reference CCD as the benchmark.

Using the above constructed adjustment model to construct the error equation, the specific form of this equation is similar to Eq. (18), the difference is that the parameters to be solved here are the constant terms of the viewing angle model of all non-reference CCDs, as follows:

$$\{ \begin{matrix}{v}_{IL}^{Fi} = {D}_{i}^{F} z + {E}_{i}^{F} {t}_{i} - {H}_{i}^{F} \\ {v}_{IL}^{B} = {D}_{i}^{B} z + {E}_{i}^{B} {t}_{i} - {H}_{i}^{B}\end{matrix} \qquad ( 21 )$$

In which, z=[dz₁, dz₂ . . . dzₙ]^{T} is the corrections of constant term for all non-reference CCDs, where dz=[da₀, db₀]ᵢ and n is the number of non-reference CCDs; tᵢ is still the correction vector of the ground plane coordinates of each corresponding imagery point; and Ds are the partial derivative matrices on the constant term of calibration parameters in the corresponding error equations, respectively; Eᵢ^{F} and Eᵢ^{B} are the partial derivative matrices on ground plane coordinates in the corresponding error equations, respectively; Hᵢ^{F} and Hᵢ^{B} are the constant vectors in the corresponding error equations, respectively.

Finally, the estimation of z can be deduced according to the least squares adjustment:

$$z = {( {\sum }_{i = 1}^{k} ( {D}_{i}^{T} {D}_{i} - {D}_{i}^{T} {{E}_{i} ( {E}_{i}^{T} {E}_{i} )}^{- 1} {E}_{i}^{T} {D}_{i} ) )}^{- 1} ( {\sum }_{i = 1}^{k} ( {D}_{i}^{T} {H}_{i} - {D}_{i}^{T} {{E}_{i} ( {E}_{i}^{T} {E}_{i} )}^{- 1} {E}_{i}^{T} {H}_{i} ) ) \qquad ( 22 )$$

In which, λ represents the number of corresponding imagery points used for the calculation, and

$${D}_{i} = [ \begin{matrix}{D}_{i}^{F} \\ {D}_{i}^{B}\end{matrix} ] , E = [ \begin{matrix}{E}_{i}^{F} \\ {E}_{i}^{B}\end{matrix} ] , {H}_{i} = [ \begin{matrix}{H}_{i}^{F} \\ {H}_{i}^{B}\end{matrix} ] ,$$

The solution of relative internal calibration is also an iteration process, and the current calibration parameters are updated according to the estimated corrections in each iteration, and be used as the inputs in next iteration. The iterative solution ends when the estimated corrections in two consecutive iterations is less than a threshold.

In summary, the method achieves fully autonomous geometric calibration of the LARSS aiming at correcting the systematic geometric errors in the imaging model, based on the joint observation for stars and earth by satellites, under the condition without ground calibration sites. The external calibration is achieved using the star observations to determine the exact viewing axis direction of the camera. The internal calibration is achieved through the ground overlapping images to realize the compensation of absolute and relative geometric distortion within the camera. Therefore, this method is suitable for satellites with various designs such as multi-CCDs splicing and multi-bands registration and so on.

What is claimed is:

1. A method of fully autonomous geometric calibration for LARSS relying on a joint observation for stars and earth by satellites, and the method comprising:
obtaining star images in a solar shadow region using satellite's agile maneuvers and extracting star positions from the star images;
constructing an on-orbit geometric external calibration model by introducing generalized installation angles into a rigorous star imaging model;
estimating the generalized installation angles using the extracted sequential star observations, in which a collinearity relationship between imagery point and star point is used to construct an adjustment model, and a least squares adjustment algorithm is adopted for parameter estimation;
obtaining ground overlapping images in a solar illumination region based on satellite's agile mobility and an overlap requirement, and identity dense corresponding imagery points from the overlapping images;
constructing an internal calibration model by introducing a fitted viewing angle model into a rigorous earth imaging model; and
estimating coefficients of the fitted viewing angle model using coplanar constraints between the overlapping images.

2. The method of claim 1, wherein a systematic geometric error in full imaging link of a linear-array remote sensing satellite (LARSS) is calibrated using the joint observation for stars and the ground overlapping images, instead of reference data of calibration sites, which overcomes shortcomings of traditional methods due to their strong dependence on ground calibration sites, reducing calibration cost and improving calibration timeliness.

3. The method of claim 1, wherein constructing an on-orbit geometric external calibration model by introducing a generalized installation angles into a rigorous star imaging model comprises expressing geometric errors of external orientation parameters using the generalized installation angles, determining an optical aberration correction angle, establishing a transform quaternion to correct optical aberration in the rigorous star imaging model, establishing the geometric external calibration model using the rigorous star imaging model.

4. The method of claim 3, wherein an optical aberration is corrected by a matrix in the rigorous star imaging model; by separating the optical aberration error in the star imaging model, it is ensured that the installation angles determined by the star-based external calibration is consistent with that in the earth imaging model of internal calibration, so as to ensure the complementarity of internal and external calibration without coupling.

5. The method of claim 1, wherein generalized installation angles are estimated using sequential star observations, and a least squares adjustment algorithm.

6. The method of claim 1, wherein overlap degree between the overlapping images collected by the same Charge-coupled Device (CCD) needs to be between 45% and 75%, and the optimal overlap degree is 65%.

7. The method of claim 1, wherein constructing an internal calibration model comprises expressing internal orientation errors of a camera using the fitted viewing angles of CCD detectors, constructing the rigorous earth imaging model, and constructing the internal calibration model by introducing the fitted viewing angle model into the rigorous earth imaging model.

8. The method of claim 1, wherein estimating coefficients of the fitted viewing angle model using coplanar constraints between overlapping images comprises constructing an adjustment model for internal calibration, performing absolute internal calibrations CCD by CCD, and performing an integrated relative internal calibration of all CCDs.

9. The method of claim 8, wherein absolute geometric distortions of each CCD and the relative geometric distortions among CCDs are both calibrated; therefore, all CCDs are registered under the same external installation angles.

10. The method of claim 8, wherein the adjustment model for internal calibration is established through using the common ground coordinates as the connection to express the coplanar condition of corresponding imagery points.

11. The method of claim 8, wherein absolute internal calibrations are performed CCD by CCD using the corresponding imagery points, and constant terms in the viewing angle model of each CCD are not estimated, because of their independence from coplanar conditions; due to the correlation between estimated parameters in internal and external calibration, not calculating constant term does not affect calibration accuracy, it can be considered that the errors of these constant terms have been compensated in external calibration.

12. The method of claim 8, wherein the corresponding imagery points between overlapping images of adjacent CCDs are used to perform relative internal calibration of all CCDs, and relative internal calibration parameters for all CCDs are estimated together through an overall adjustment, to suppress error accumulation among CCDs.

13. The method of claim 12, wherein a CCD is selected as a reference CCD, and the constant terms in the viewing angle models of all non-reference CCDs are estimated based on the reference CCD, to ensure the accuracy and stability of the overall adjustment.

14. A computing device for executing the method of claim 1, the device comprising a processor, and a memory that comprises instructions that, when executed by the processor, cause the processor to perform acts comprising: reading the collected star images, the ground overlapping imagery, the attitude auxiliary data, the orbit auxiliary data, and the imaging time auxiliary data into the memory, conducting the star points extraction and corresponding imagery points matching, conducting the external calibration and the internal calibration according to method of the disclosure, and then outputting the estimated accurate installation angles and coefficient of the viewing angle model into the memory.
